(19) United States
(12) Patent Application Publication
(10) Pub. No.: US 2017/0364316 A1
(43) Pub. Date: Dec. 21, 2017

(54) MATERIAL VOLUME COVERAGE REPRESENTATION OF A THREE-DIMENSIONAL OBJECT

(71) Applicant: HEWLETT-PACKARD DEVELOPMENT COMPANY, L.P., Houston, TX (US)

(72) Inventors: Peter Morovic, Sant Cugat del Valles (ES); Jan Morovic, Colchester (GB)

(73) Assignee: HEWLETT-PACKARD DEVELOPMENT COMPANY, L.P., Houston, TX (US)

(21) Appl. No.: 15/540,160

(22) PCT Filed: Jan. 30, 2015
(86) PCT No.: PCT/EP2015/052002

§ 371 Date: Jun. 27, 2017

(51) Int. Cl. G06F 3/12; B33Y 50/02; H04N 1/405; G06F 17/50; B29C 67/00; B33Y 99/00

(52) U.S. Cl. CPC G06F 3/1245; H04N 1/405; G06F 17/50; B33Y 50/02; B33Y 99/00; B29C 67/00

(57) ABSTRACT

Certain examples described herein provide a representation of a three-dimensional object for production of said object. These examples use a material volume coverage representation that is generated from received object data, such as a vector object representation. The material volume coverage representation includes material volume coverage vectors for at least volumes forming part of a raster representation of the three-dimensional object. The raster representation is generated from the vector representation. Each material volume coverage vector represents a probabilistic distribution of materials available to the apparatus for production of the three-dimensional object and combinations of said materials.

### BACKGROUND

Apparatus that generate three-dimensional objects, including those commonly referred to as “3D printers”, have been proposed as a potentially convenient way to produce three-dimensional objects. These apparatus typically receive a definition of the three-dimensional object in the form of an object model. This object model is processed to instruct the apparatus to produce the object using one or more material components. This may be performed on a layer-by-layer basis. It may be desired to produce a three-dimensional object with one or more properties, such as color, mechanical and/or structural properties. The processing of the object model may vary based on the type of apparatus and/or the production technology being implemented. Generating objects in three-dimensions presents many challenges that are not present with two-dimensional print apparatus.

### BRIEF DESCRIPTION OF THE DRAWINGS

Various features of the present disclosure will be apparent from the detailed description which follows, taken in conjunction with the accompanying drawings, which together illustrate, by way of example only, features of the present disclosure, and wherein:

FIG. 1A is a schematic diagram showing a pipeline for generating a material volume coverage representation of a three-dimensional object according to an example;

FIG. 1B is a schematic diagram showing a pipeline for generating control data for production of a three-dimensional object using a material volume coverage representation according to an example;

FIG. 2 is a schematic diagram showing an apparatus for production of a three-dimensional object according to an example;

FIG. 3 is a flow diagram showing a method for generating a material volume coverage representation of a three-dimensional object according to an example;

FIG. 4A is a flow diagram showing a method for generating a material volume coverage representation at a virtual resolution according to an example;

FIG. 4B is a flow diagram showing a method for producing a three-dimensional object according to an example;

FIG. 5 is a schematic diagram of a process for producing a three-dimensional object according to an example; and

FIG. 6 is a schematic diagram showing a file structure for use in production of a three-dimensional object according to an example.

### DETAILED DESCRIPTION

Certain examples described herein provide a representation of a three-dimensional object that facilitates production of that object. These examples use a material volume coverage representation that is generated from received object data, such as a vector object model or representation. The material volume coverage representation comprises material volume coverage vectors for at least volumes forming part of a raster representation of the three-dimensional object. The raster representation is generated from the vector representation. Each material volume coverage vector represents a probabilistic distribution of materials available to the apparatus for production of the three-dimensional object and combinations of said materials. This is in contrast to comparative examples that use a normalized vector of build materials, e.g. these comparative examples do not provide a probabilistic distribution nor do they consider combinations of all available materials, which may include a vector component representing no material, e.g. a “blank” representation.

Material volume coverage representations, as described in examples herein, enable a decoupling of the constraints of a specific apparatus from the processing of received object data. In certain examples, at production time, the material volume coverage representation may be, either directly or via an intermediate print representation, halftoned to generate control data for the apparatus. Choices concerning the production of the three-dimensional object may thus be made at the halftoning stage. This speeds up production of a three-dimensional object as processing to convert from a vector representation, and to control for specified color and/or material properties, has already been performed; the color and/or material properties are represented by the material volume coverage vectors that may be easily linearly combined, e.g. as they are based on probabilistic distribution. Therefore, choices such as a direction of layering, print resolution and overall geometry of layer slicing may be made, and varied, without having to re-perform the aforementioned processing; they do not affect the processing of the initial object data but are instead used to rapidly generate a print resolution material volume coverage representation that is then halftoned to generate control data for production. In general, the examples described herein provide various portions of a full and native three-dimensional processing pipeline for the production of three-dimensional objects.

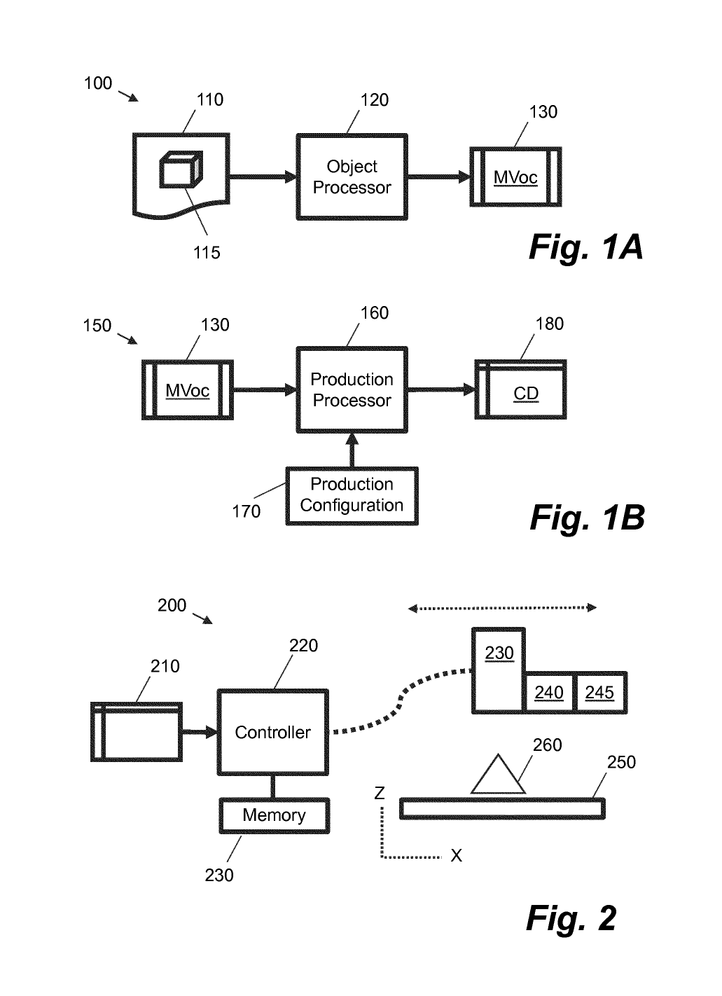

FIG. 1A shows schematically an example 100 of a first portion of a three-dimensional processing pipeline. In the example 100, object data 110 comprising a vector representation 115 is received by an object processor 120. The object processor 120 processes the object data 110 to generate a material volume coverage (M-Vo-C or MVoc) representation 130 of the three-dimensional object. The material volume coverage representation 130 comprises material volume coverage vectors for at least volumes forming part of a raster representation of the three-dimensional object. Each material volume coverage vector represents a probabilistic distribution of materials available to an apparatus for production of the three-dimensional object and combinations of said materials. The probabilistic distribution relates to all combinations of materials, e.g. build, finishing, agents and powders, including separate use of materials, joint use of materials, and an absence of any materials.

The object processor 120 is arranged to convert three-dimensional object model data received in a vector-based format, e.g. data from a STereoLithography “.stl” file, to a predetermined raster resolution. Vector-based formats represent a three-dimensional object using defined model geometry, such as meshes of polygons and/or combinations of three-dimensional shape models. For example, a “.stl” file may comprise a vector representation in the form of a list of vertices in three dimensions, together with a surface tessellation in the form of a triangulation or association between three vertices. Raster-based formats represent a three-dimensional object as a series of unit volumes referred to herein as “voxels”, in a similar manner to the way in which a two-dimensional image is divided into unit areas referred to as “pixels”. In one case, cubic volumes may be used with a common value for each of the height, width and depth of a voxel. In other cases, custom unit volumes or voxels may be defined, e.g. where the unit volume is non-cubic and/or has values of height, width and depth that differ from each other with (although each voxel has the same height, width and depth as other voxels in the raster representation). In certain cases, the unit volume or voxel may be a non-standard or custom-defined three-dimensional shape.

In one case the unit volumes or “voxels” are aligned against a grid resolution. For example, consider a simple case where the received object data comprises a model of a three-dimensional object bounded by a cubic volume. In this case each of the x, y and z axes of the bounding volume may be divided into units, e.g. a bounding 20 cm*20 cm*20 cm volume of the vector representation may have a raster resolution of 2 cm/voxel, wherein each axis is split into divisions of 10 and the bounding volume is split into 1000 voxels (10*10*10). Each unit volume of voxel is then assigned a material volume coverage vector based on color and/or material properties defined for the three-dimensional object, e.g. in the object data.

As described above, in certain implementations voxels may have custom or non-standard volumes, e.g. of a form that is not a regular cubic sub-division. For example, in one case, an x-y resolution may differ from a z-resolution, e.g. the bounding volume above may be split into 2500 voxels with a resolution of 10*10*25. In other cases voxels may be based on Delaunay tessellations (e.g. tetrahedra that fill the object) or any other space-filling polyhedra.

To explain the components of a material volume coverage vector, a simple example may be considered. In this simple example, an apparatus is arranged to use two materials to generate a three-dimensional object: M1 and M2. These may be fluid build materials that are deposited on a substrate or platen, or they may comprise two deposit-able colored agents that are deposited on one or more layers of powdered build material. In one case, these materials may comprise combinations of at least one of agents, inks and powdered build materials. In one case the materials may relate to one of agents, inks and powdered build materials and/or may relate to a subset of these materials. If the apparatus is arranged to deposit discrete amounts of each material, e.g. in binary deposits, there are four different material combination states: a first state for the deposit of M1 without M2; a second state for the deposit of M2 without Ml; a third state for the deposit of both M1 and M2, e.g. M2 deposited over M1 or vice versa; and a fourth state for an absence of both M1 and M2, e.g. “blank” (Z) or an inhibitor. In this case, the material volume coverage vector has four vector components: [M1, M2, M1M2, Z]. Each voxel of a raster representation thus has a material volume coverage vector of this form. In the case of the last vector component, “blank” or “Z” may represent “empty” or an absence of materials in a processed layer, e.g. if agents are deposited on layers of build material this may denote an absence of build material for the processed layer, even though the build material may not be removed until the complete object has been produced.

This may be contrasted with a comparative method that associates material proportions to each voxel. In these comparative methods, a percentage of each of materials M1 and M2 are defined for each voxel, e.g. [M1, M2] wherein the vector is normalized to 1 (for ranges of 0-1) or 100% (for percentage ranges). In this comparative case, there is no consideration of the combination of M1 and M2, nor is there a consideration of the absence of both materials. As such these comparative methods do not consider material combinations; without considering the material combinations the defined material proportions cannot be linearly combined and exhibit non-linearities that make processing problematic. Additionally, the definition and use of material combinations provide more accurate and exact control of the materials that are used. For example, particular values for a given percentage of each of materials M1 and M2 as defined for a voxel, e.g. [M1=0.5, M2=0.5], may be controlled using a plurality for material volume coverage vector values, e.g. various combinations of M1, M2 and M1M2. Defining the absence of any material (“Z”) as a particular material combination also further facilitates this control.

More generally, for an apparatus having k available materials and L discrete deposit states for said materials, a material volume coverage vector comprises L^{k} vector components, each vector component representing an available material/deposit state combination, including separate and joined use and an absence of any material. Or in other words, the vector components of a material volume coverage vector represent all materials available to an apparatus and their combinations, they are an enumeration of possible build or deposit states available to the apparatus. These states are the “material primaries” discussed herein. As such the material volume coverage vector has a dimensionality representative of these states and contains the volume coverages (e.g. probabilities) associated with each state. Or in other words, a material volume coverage vector (MVoc) comprises weighted combinations or probabilities of material primaries. This compares to the comparative methods discussed above that have k vector components. As can be seen, the present examples and the comparative methods rapidly diverge when a plurality of materials are available with a plurality of production build states; material volume coverage space is much greater than comparative material representation spaces. The vector components of a material volume coverage vector represent all materials available to an apparatus and their combinations. These materials may comprise, amongst others, any combination of: different build materials, different binders, different material property modifiers, different build powders, different agents, different epoxies and different inks. This provides another distinction when compared to comparative methods: any materials available to the apparatus may be included in the material volume coverage vector, e.g. this need not be limited to available colored build materials. In one case, depending on the implementation, the “available materials” may be a selected subset of materials, e.g. may comprise activated or deposit-able materials for a particular production run.

In the example of FIG. 1A the material volume coverage representation may be stored for later use in production and/or passed to a second portion of the three-dimensional processing pipeline. In the first case, the material volume coverage representation may be stored as a file in a computer-readable storage medium for use in producing versions of the three-dimensional object in the future. For example, the file may be passed in a physical medium, transmitted over a network and/or digitally copied so as to control future production of one or more of said versions. An example file structure is described later below with reference to FIG. 6. Future production may take place on the second portion of the three-dimensional processing pipeline.

FIG. 1B shows schematically an example 150 of the second portion of a three-dimensional processing pipeline. In the example 150, a material volume coverage representation 130, e.g. the representation output in FIG. 1A, is received by a production processor 160. The production processor 160 also receives a production configuration 170. The production configuration 170 comprises data regarding the production of the three-dimensional object defined in the material volume coverage representation 130. The production processor 160 is arranged to apply the production configuration 170 to the material volume coverage representation 130 to generate control data 180 for the production of the three-dimensional object on a given apparatus. The control data 180 may comprise deposit instructions for materials available to the given apparatus, e.g. discrete instructions representing one or more available deposit states for the given apparatus.

In one case, a given apparatus is arranged to generate a three-dimensional object in a layer-by-layer manner. In this case, the production processor 160 may receive data such as a slicing or layer plane direction, an output resolution and a layer thickness as production configuration 170. The generation of control data 180 by the production processor 160 may thus comprise processing the material volume coverage representation 130 such that division in the layer plane direction, with the output resolution and/or the layer thickness is possible. If there were 5 layers with a thickness of 4 cm that were aligned with the z-axis (e.g. z-plane slices), then with reference to the previous example with a 10*10*10 resolution, this may comprise generating a print representation with a 10*10*5 resolution (with respect to the x, y and z axes). In this case, generation of a print representation comprises a linear combination of the material volume coverage vectors, e.g. linear, volume-weighted averaging. This action maintains the properties for the voxels of the original resolution at the new print resolution.

For example, given a 1*1*2 array of voxels with different material volume coverage vectors for each z-plane layer (e.g. MVoc₁ and MVoc₂) that need to be combined to a single z-plane layer, a new material volume coverage vector (MVoc₁₂) may be computed by linearly combining the two material volume coverage vectors, e.g. MVoc₁₂=0.5*MVoc₁+0.5*MVoc₂. The new material volume coverage vector may then be halftoned over the new volume, which is double that associated with MVoc₁ and MVoc₂, and proportionally half of the new volume will use the components of Mvoc₁ while the other half will use Mvoc₂ (according to the distributions of MVoc₁₂). By virtue of the halftoning operation both old material volume coverage vectors are intermixed spatially in the new volume.

In one case, the production processor 160 is arranged to apply halftoning to the material volume coverage representation of the three-dimensional object to generate control data for the apparatus for production of the three-dimensional object. Halftoning may be applied to either the original material volume coverage representation or, in another case, a separately generated print-resolution material volume coverage representation that is produced from the original material volume coverage representation. Halftoning may be applied layer-by-layer, e.g. on a per slice basis, or for the full three-dimensions of the material volume coverage representation. The former case may comprise applying a threshold matrix per slice, e.g. in two-dimensions, and the latter case may comprise applying a three-dimensional threshold matrix, e.g. an operation in three-dimensions. A threshold matrix may comprise a dispersed-dot type pattern, such as whitenoise or blue-noise, or clustered-dot types, such as green-noise, AM-screen-like patterns, or others. In certain cases, error diffusion may be used instead of or as well as a threshold matrix. The result of the halftoning operation is control data comprising a set of instructions for the apparatus for production of the three-dimensional object. For example, if there are two available materials, M1 and M2, that may be deposited in a binary manner in a series of addressable locations in three-dimensions, the instructions may comprise voxels at the resolution of production and one of the array: [0, 0]—blank; [1, 0]—deposit M1; [0, 1]—deposit M2; and [1, 1]—deposit M1 and M2.

In one case halftoning may comprise a thresholding operation whereby a value from a threshold matrix is compared against the probability distribution defined by a material volume coverage vector. For example, if a material volume coverage vector has three components each with values of 33%, a cumulative distribution may be generated with three intervals [0-33%, 33%-66%, 66%-100%]. In this case, if a threshold value from the threshold matrix has a value that falls within the first range [0-33%], then an instruction for deposit of the first material or material combination is output. Similarly, if a threshold value from the threshold matrix has a value that falls within the second range [33-66%], then an instruction for deposit of the second material or material combination is output and if a threshold value from the threshold matrix has a value that falls within the third range [66-100%], then an instruction for deposit of the third material or material combination is output. In this case the threshold matrix is configured to provide a uniform (although not regular) distribution of threshold values and as such over a particular area or volume 33% of the area or volume will have each of the three components.

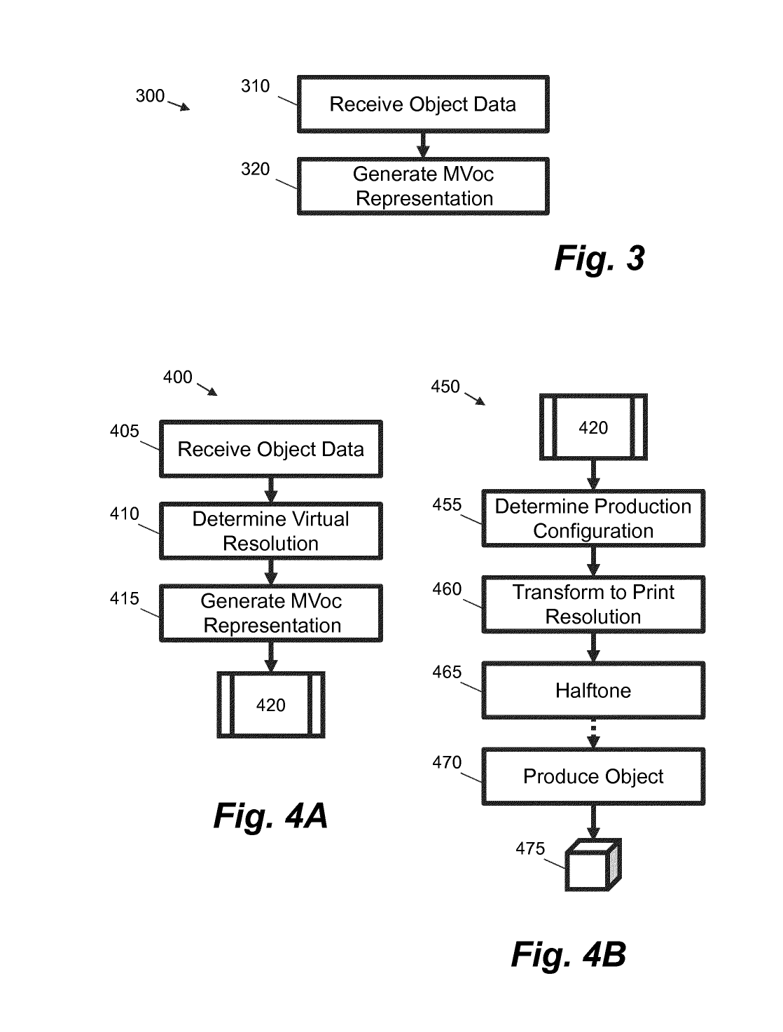

FIG. 2 shows an example of an apparatus 200 arranged to produce a three-dimensional object 260. The apparatus 200 is arranged to receive data 210 for the three-dimensional object. The apparatus 200 comprises a production controller 220 and a memory 230. The production controller 220 may comprise one or more processors that form part an embedded computing device, e.g. adapted for use in controlling an additive manufacturing system. Memory 230 may comprise volatile and/or non-volatile memory, e.g. a non-transitory storage medium, arranged to store computer program code, e.g. in the form of firmware. The production controller 220 is communicatively coupled to aspects of the apparatus that are arranged to construct the three dimensional object. These comprise a build mechanism 230 and a supply mechanism 240, 245. In the schematic example of FIG. 2, the supply mechanism 240, 245 comprise two components: a first component 240 for the supply of a first material (e.g. build material M1 as discussed above) and a second component 245 for the supply of a second material (e.g. build material M2 as discussed above). Two materials are presented in this example for ease of explanation but any number of materials may be supplied. The build mechanism 230 is arranged to deposit a combination of one or more material components from the set of material components to produce the three-dimensional object 260. In the example of FIG. 2, the three-dimensional object 260 is built layer by layer on a platen 250. The arrangement of the aspects and components shown in FIG. 3 are not limiting; the exact arrangement of each apparatus will vary according to the production technology that is implemented and the model of apparatus.

In the example of FIG. 2 the production controller 220 is configured to process and/or otherwise use the data 210 to control one or more of the build mechanism 230 and the supply mechanism 240, 245. In one implementation the apparatus 200 may be arranged to use a coalescing agent and a coalescing modifier agent that are respectively supplied by the components of the supply mechanism 240, 245. These agents allow a three-dimensional object to have varying material properties. They form part of the “materials” of the material volume coverage vector. They may be combined with one or more colored build materials, e.g. applied using an inkjet mechanism to deposited powder layers, to generate multi-color objects with varying material properties. The build materials also form part of the “materials” of the material volume coverage vector. The generated objects may be constructed by depositing at least the coalescing agent and the coalescing modifier agent on layers of build material, e.g. layers of powder or other material forming z-plane slices, followed by the application of energy to bind the material, e.g. infra-red or ultra-violet light. For example, one or more of the build mechanism 230 and the supply mechanism 240, 245 may be moveable relative to the platen 250, e.g. in one or more of the x, y and z directions (wherein the y axis is into the sheet for FIG. 2). One or more of the build mechanism 230, the supply mechanism 240, 245 and the platen 250 may be moveable under control of the production controller 220 to achieve this. Additionally, one or more inks may also be deposited on cured and/or uncured layers, wherein these inks also form part of the “materials” of the material volume coverage vector. In other implementations the apparatus may comprise part of, amongst others, selective laser sintering systems, stereo lithography systems, inkjet systems, fused deposition modelling systems, any three-dimensional printing system, inkjet deposition systems and laminated object manufacturing systems. These include apparatus that directly deposits build materials may be used, rather than those described that use various agents.

In one case, the production controller 220 is configured to receive control data 180. For example, one or more of the pipelines shown in FIGS. 1A and 1B may be located on a computer device that is communicatively couplable to the apparatus 200. The pipelines shown in FIGS. 1A and 1B may further be located on separate computing devices separately by one or more of space and time, e.g. object processor 120 may be implemented by a remote server device (e.g. a hosted or “cloud” computing service) and production processor 160 may be implemented by a local personal computer or mobile device in communication with the apparatus 200 (or any associated combination).

In another case, one or more of the pipelines shown in FIGS. 1A and 1B may be implemented by production controller 220; e.g. data 210 may comprise either object data 110 or material volume coverage representation 130. This may be the case for a “stand alone” apparatus that is arranged to receive, e.g. by physical transfer and/or over a network, object data 110 and produce an object accordingly. In one case a data interface, e.g. any combination of hardware and control program code, may be arranged to act as a receiver to receive the material volume coverage representation of the three-dimensional object.

FIG. 3 shows a method 300 for processing object data for an apparatus accordingly to an example. The apparatus may comprise an apparatus similar to that shown in FIG. 2 and/or the method 300 may be performed by the controller 220, or another computer device, processing computer program code stored in memory 230. At block 310, object data comprising a vector representation of the three-dimensional object is received. This may comprise object data 110. At block 320, the object data is processed to generate a material volume coverage representation of the three-dimensional object. This may comprise material volume coverage representation 130. The material volume coverage representation comprises material volume coverage vectors for at least volumes (i.e. voxels) forming part of a raster representation of the three-dimensional object, wherein each material volume coverage vector representing a probabilistic distribution of materials available to the apparatus for production of the three-dimensional object and combinations of said materials.

FIG. 4A shows a method 400 that is a variation of the method 300. At block 405 object data is received, e.g. in a similar manner to block 310. At block 410, a virtual resolution in three dimensions is determined for a raster representation of the three-dimensional object. At block 415, material volume coverage vectors for volumes at the virtual resolution are determined to generate a material volume coverage representation 420.

In one case, block 410 comprises determining a bounding volume of the object represented in the received vector-format data. For example, this may be the smaller cubic volume that encloses the vector model of the object. The virtual resolution may then be determined in relation to this bounding volume. In other cases, the bounding volume may have a custom geometry, e.g. need not be cubic.

In one case, the virtual resolution is determined based on one or more of, amongst others, the geometric properties of the three-dimensional object, the size of the three-dimensional object, the material properties of the three-dimensional object and the physical capabilities of the apparatus, e.g. the smallest addressable area or volume for deposit of material. In this case, the latter may determine an upper bound for the virtual resolution. For example, the three-dimensional shape of a unit volume or voxel may depend on these factors.

In one case, block 410 comprises, for each given volume forming part of a raster representation of the three-dimensional object, determining whether a center of the given volume (i.e. voxel) is within the three-dimensional object, as defined by the vector representation. In one implementation this may comprise, for every [x, y, z] location of a virtual-resolution grid, determining whether the location is or is not within the three-dimensional object as defined by the object data, e.g. where the object data represents an object model. In this case, responsive to the center of the given volume being within the three-dimensional object, the block may further comprise determining a set of properties for the given volume that are desired in a produced version of the three-dimensional object. These properties may be one or more of: material properties, mechanical properties, color, detail, roughness, conductivity and magnetism. This may comprise considering where within the object model the volume is and determining what properties are associated with that spatial location for the final produced object. For example, the location may be on the surface and have a color or other material property information, or the location may be inside the object and have other material and/or mechanical property information associated with it.

Based on the aforementioned properties, values for the material volume coverage vector for the given volume may be calculated using a property-vector separation, the property-vector separation mapping one or more property values to material volume coverage vector values. For example, in a simple case the property-vector separation may comprise a look-up table that maps Red, Green, Blue (RGB) color values to MVoc vector values. The look-up table may comprise a set of mappings, referred to as nodes. Mappings for values that lie between the nodes may be computed by interpolation. A more advanced mapping may map color, rigidity and conductivity values to MVoc vector values, e.g. [R, G, B, rigidity, conductivity]>[MVoc]. In other cases, color may be defined by colorimetric values, e.g. based on the International Commission on Illumination (CIE) 1931 XYZ color space, wherein three variables (‘X’, ‘Y’ and ‘Z’ or tristimulus values) are used to model a color, or the CIE 1976 (L*, a*, b*—CIELAB or ‘LAB’) color space, wherein three variables represent lightness (‘L’) and opposing color dimensions (‘a’ and ‘b’). One or more property-vector separations may be used. The mappings may be determined through apparatus characterization tests, performed either at a design stage and/or by a user as a configuration stage following installation of the apparatus.

In one case, responsive to the center of the given volume not being within the three-dimensional object, the block further comprises either setting the material volume coverage vector as blank, e.g. [M1, M2, M1M2, Z]>[0, 0, 0, 1], or using materials configured for locations outside of the three-dimensional object, e.g. a binding inhibitor.

The output of the method 400 of FIG. 4A comprises data representative of a rasterized three-dimensional object at a virtual resolution whereby every volume (i.e. voxel) has an associated material volume coverage vector. This may comprise a three-dimensional array of [x,y,z] co-ordinates, representing the center of the volumes, and material volume coverage vector values. An example is described later with reference to FIG. 6.

FIG. 4B shows a further method 450 for generating control data for an apparatus. Again, the apparatus may comprise an apparatus similar to 200 in FIG. 2, or any other form of apparatus arranged to produce a three-dimensional object. The method 450 may be implemented independently, e.g. may be implemented by controller 220 on receipt and/or generation of a material volume coverage representation 420.

The method 450 begins with the receipt of a material volume coverage representation 420 of the three-dimensional object. This may be a material volume coverage representation 130 as output by the object processor 120 of FIG. 1A and/or the material volume coverage representation 600 of FIG. 6. The material volume coverage representation 420 represents a three-dimensional object to be produced on an apparatus, such as that illustrated in FIG. 2. At block 455, a production configuration of the apparatus for production of the three-dimensional object is determined. This may comprise the production configuration 170 of FIG. 1B. If method 450 is implemented by controller 220, the controller may have access to a production configuration of the apparatus. In another case, the production configuration may be received over a communication coupling, e.g. supplied by the controller 220 and/or a coupled computer device in response to a network request. In this example, block 455 also includes determining a layer plane direction and a layer thickness, e.g. this data may be included in the production configuration.

At block 460, at least a portion the received material volume coverage representation 420 is transformed from a virtual resolution to at least a layer of a print resolution. The virtual resolution may be the resolution set in block 410 of FIG. 4A. In certain cases the virtual resolution may be defined in the received material volume coverage representation 420, e.g. as a header in any file format. In one case, the complete three-dimensional extent of the material volume coverage representation 420 is transformed to the print resolution; in another case this is performed layer by layer. The print resolution is based on the production configuration, e.g. at least the layer plane direction and the layer thickness.

In certain cases, during production, feedback from the apparatus may be used to adjust the production configuration. This may be received by a feedback interface that is communicatively coupled to both one or more sensors and the production controller 220 of FIG. 2. In this case, different layers may have different print resolutions. In one case, the halftoning may be applied to the virtual-resolution material volume coverage representation at the print resolution to transform to the print resolution. For example, if a cube has a common material volume coverage vector then halftoning may be performed at the print resolution on the single material volume coverage vector. This may be beneficial in terms of memory use. In general, as long as a correspondence between the locations at the two resolutions is known, halftoning may be performed for a location at the print resolution using a material volume coverage vector from a corresponding location in the virtual resolution representation.

In one example, feedback may be based on a thermal measurement, e.g. from above the platen 250, a layer thickness may be increased or reduced. Block 460 may comprise adjusting a volume that a location corresponds to (e.g. the center of a voxel at the virtual resolution) by altering the width, height and/or depth of a voxel. For example, if the print resolution was half that of the virtual resolution in each direction, then a given material volume coverage vector may be recomputed as the weighted average (or convex combination) of a volume of 2×2×2 virtual resolution voxels, the resultant recomputed material volume coverage vector being associated with a single new voxel at the print resolution.

At block 465, halftoning is applied to the at least one layer of the material volume coverage representation at the print resolution to generate control data for the apparatus for production of at least one layer of the three-dimensional object, the control data indicating deposit instructions for the materials available to the apparatus. Halftoning may be performed for a given slice of voxels as many times as needed, e.g. in terms of how many layers should be printed from the given slice. In this example, the halftoning is three-dimensional, e.g. subsequent halftones or slices of the same voxels will result in different halftone patterns, as dictated by a set of two-dimensional, or a single three-dimensional, halftone thresholding matrix.

In one case, the method 450 of FIG. 4B may stop with block 465, as denoted by the dashed line between blocks 465 and 470. For example, blocks 455 to 470 may be performed by a print driver of a computing device, whereas block 470 may be performed at a subsequent time by a controller such as 220 in FIG. 2. In another case, all the blocks 455 to 470 may be enacted as a single continuous process. The exact configuration may depend on the implementation.

In FIG. 4B, at block 470, at least one layer of the three-dimensional object is produced using the apparatus based on the control data output by block 465. Block 470 may be repeated for each layer of the three-dimensional object. In certain cases, each of blocks 455 to 470 may be repeated for a plurality of layers so as to construct the three-dimensional object. In other cases, at block 470, the complete three-dimensional object may be produced. In any case, at the end of the method 450, a three-dimensional object 475 is produced.

As discussed above, in one case, following the production of one or more layers at block 470, feedback from the apparatus may be sent to a controller such as 220 or another controlling computer device. Based on this feedback the production configuration of the apparatus may be modified. This feedback may be closed loop feedback. The feedback may comprise, amongst others, thermal imaging informing of a uniformity of applied heat (e.g. from an infra red or ultra violet source to bind build material with deposited coalescing agent) and two or three dimensional imaging informing of any geometric deformations. The modifications may be made to configurations for one or more of individual parts of a three-dimensional object, areas and/or slices of an object to be produced. Following the modifications, at least one additional layer of the material volume coverage representation from the virtual resolution may be transformed to a modified print resolution. The modified print resolution being based on the modifications to the production configuration. Halftoning may then be applied to the at least one additional layer of the material volume coverage representation at the modified print resolution to generate additional control data for the apparatus. This enables production of at least one additional layer of the three-dimensional object, e.g. a repetition of block 470.

Certain examples described herein provide a late-binding pipeline that involves a native three-dimensional rasterized object coupled with a volumetric representation as provided by the material volume coverage representation. This allows for dynamic halftone generation as described above at production-time. This may comprise a spatially independent thresholding operation. This can allow “on-line” feedback and correction, and allow for modifications to be performed in “production time”, e.g. at speed during production.

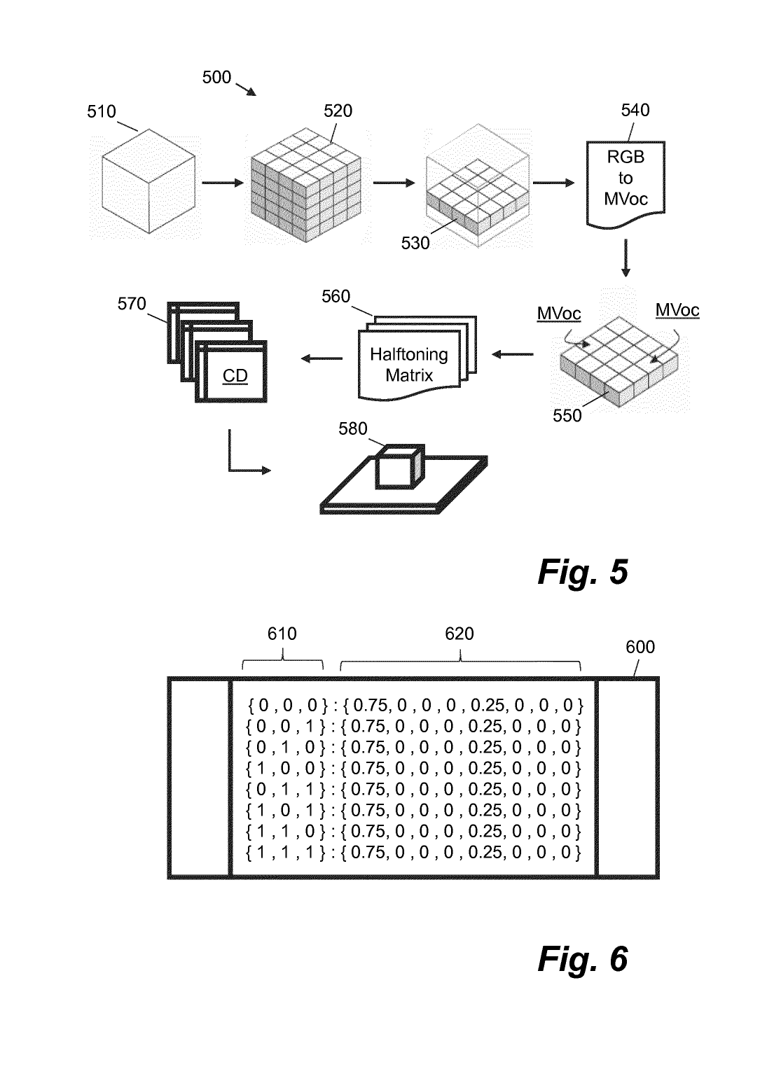

FIG. 5 shows an example of a process 500 for producing a three-dimensional object. This process 500 combines several of the aspects described above into an end-to-end three-dimensional processing pipeline. At stage 510, a vector object is received. In FIG. 5 this is a cube. It may be defined as object data, e.g. in an “.stl” file or other file format. At stage 520, a rasterized voxel representation is generated in a virtual resolution grid. In this grid every voxel assumes volume meaning in relation to the final printed object and/or its object properties (e.g. color). In this example each voxel has a width, height and depth, e.g. dimensions in each of the x, y and z dimensions, with the volume being equal to the width times the height times the depth. At stage 530, a single layer of the rasterized representation is selected. In FIG. 5 this is shown as a single z-plane layer for ease of example; however, layers may also be selected that are parallel, or at an angle to, any of the axes. In this example, at stage 540, an RGB to MVoc separation is applied to convert from RGB color data received with the object to an MVoc vector, e.g. a vector per voxel or unit volume (each constituent cube of the layer shown at stage 530). An RGB to MVoc separation may, in a simple case, comprise 8 nodes, e.g. one for each vertex of a cube with two levels, 0 and 255. Each node may comprise a mapping between an RGB and an MVoc value, e.g.:

| RGB | MVoc |
|---|---|
| [0, 0, 0] | [Z = 0.75, C = 0, M = 0, Y = 0, CM = 0, CY = 0, MY = 0, CMY = 0.25] |
| [0, 0, 255] | [Z = 0.75, C = 0, M = 0, Y = 0, CM = 0.25, CY = 0, MY = 0, CMY = 0] |
| [0, 255, 0] | [Z = 0.75, C = 0, M = 0, Y = 0, CM = 0, CY = 0.25, MY = 0, CMY = 0] |
| [0, 255, 255] | [Z = 0.75, C = 0.25, M = 0, Y = 0, CM = 0, CY = 0, MY = 0, CMY = 0] |
| [255, 0, 0] | [Z = 0.75, C = 0, M = 0, Y = 0, CM = 0, CY = 0, MY = 0.25, CMY = 0] |
| [255, 0, 255] | [Z = 0.75, C = 0, M = 0.25, Y = 0, CM = 0, CY = 0, MY = 0, CMY = 0] |
| [255, 255, 0] | [Z = 0.75, C = 0, M = 0, Y = 0.25, CM = 0, CY = 0, MY = 0, CMY = 0] |
| [255, 255, 255] | [Z = 0.75, C = 0, M = 0, Y = 0, CM = 0, CY = 0, MY = 0, CMY = 0.25] |

This is an example case for three build materials having Cyan, Magenta and Yellow coloring (Z=“blank”). The specific separation shown provides two black vertices, at [0, 0, 0] and [255, 255, 255], as in this example the CMY materials are not able to produce a “white” colored object. Values between the nodes may be determined using interpolation. The shown separation may be extended by adding material property dimensions to the mapping, one or more of: material properties, mechanical properties, color, detail, roughness, conductivity and magnetism; all of which are mapped onto an MVoc value. In certain cases object properties may be mapped without performing a color mapping, e.g. mapping at least one object property such as flexibility, stiffness, hardness, rigidity, conductivity or magnetism to an MVoc. In certain cases object and color properties may be combined, e.g. [RGB, Flex]>[MVoc]. For example, a grayscale mapping between a 0 value with an MVoc of [Z=0.25, CMY=0.75] and a 255 value with an MVoc of [Z=0.75 CMY=0.25] may provide a separation that provides a mapping for mechanical strength (e.g. where 0 is stronger). As another example, a mapping between a 0 value with an MVoc of [Z=0.25, C=0.25, M=0.25, Y=0.25] and a 255 value with an MVoc of [Z=0.25 CMY=0.75] may provide a separation that is constant in coverage but that differs in material use.

The output at stage 550 is a set of volumes or voxels, e.g. in a z-plane layer as shown, wherein each volume has a corresponding MVoc value as determined from the mapping of stage 540. At stage 560 individual z-slices of a three-dimensional halftoning (e.g. threshold) matrix are applied. The number of individual slices of the three-dimensional halftoning matrix may depend on the number of production layers that are mapped to the set of volumes, e.g. the transformation between a virtual resolution as shown in stage 550 to a print resolution for output. In one case, a layer of voxels are halftoned into N slices/layer. This generates control data at stage 570 on a layer by layer basis that may be used to produce the three-dimensional object shown at stage 580.

In a simple implementation the virtual resolution may be the same as the print resolution. In this case, layers of voxels, e.g. as shown at stage 530 may correspond to print layers. In other cases this need not be the case; indeed there may be many print layers per layer of voxels at the virtual resolution and/or the print layers may have a different orientation to the layer of voxels at the virtual resolution.

FIG. 6 shows an example of a file structure 600 that may be used to store a material volume coverage representation. The file structure comprises a plurality of volume definitions 610 having data 620 defining the three dimensional object. In this case each volume definition has a center co-ordinate, e.g. {0, 0, 1}. The plurality of voxel definitions are defined within a virtual grid resolution in three dimensions. In one case, each volume definition has a volume set by a height, a width and a depth, wherein the height, width and depth are defined based on the virtual grid resolution. In another case, other geometric parameters that define the shape and size of the unit volumes may be defined. The data 620 comprises a material coverage vector for each volume, the material coverage vector representing a probabilistic distribution of materials available to an apparatus for production of the three-dimensional object and combinations of said materials. The number of vector components is dependent on a number of available materials. For an apparatus having k available materials and L discrete deposit states for said materials, the material coverage vector comprises L^{k} vector components. This may be compared with comparative representations that use a vector of k components that represent the available materials. In the example of FIG. 6 there are three available materials M1, M2 and M3 and two discrete deposit states (i.e. “deposit” or “no deposit”). Hence, the material volume coverage vector has eight vector components (2³). These may be: [Z, M1, M2, M3, M1M2, M1M3, M2M3, M1M2M3] using the convention discussed above. The material coverage vector of each voxel definition may combined linearly in three dimensions, e.g. by linear, volume-weighted averaging (convex combinations).

Certain examples described herein provide a volumetric representation of material combinations available to an apparatus. These materials may be inks, build materials, agents etc. For any unit volume, e.g. as defined by a voxel at a defined resolution, the probability distribution of materials within that volume are determined by the probability distribution as represented by a material volume coverage vector. A material volume coverage representation may then be halftoned to decide the locations of each of the constituent materials during production using the apparatus.

Certain examples described herein allow for native three-dimensional rasterization without vector slicing and without a-priori about how an object is to be printed. In certain cases, a print-ready halftone resolution is loosely related to the native three-dimensional raster representation. As such, the number of slices or layers to be produced does not need to be known before object data is processed. This may be contrasted with a comparative method where a three-dimensional object is intersected with a series of two-dimensional planes. In this comparative method, the resulting vector outline in each plane is converted into a two-dimensional bitmap that is halftoned for production. In these comparative cases, the z dimension is treated differently, as it has a configuration for layer printing, whereas the x and y dimensions are treated similarly to two-dimensional print. In contrast, examples described herein do not assume z-axis layering, layers can be set at any orientation in any dimension, and may also be changed even in production. These examples change the comparative order and leaves slice generation to an end of a pipeline, as well as decoupling a raster resolution from that of a print or halftone resolution, allowing different choices to guide each. Hence, the examples described herein may cope, at high (e.g. production) speeds with changes and modifications. Data stored in the example file format described herein may also be used to produce different versions of the same three-dimensional object on different apparatus, e.g. apparatus that do not share layering or resolution characteristics. With certain examples as described herein, recompilation of two dimensional vector slicing and an accompanying material separation is avoided.

Certain methods described herein may be implemented by way of computer program code that is storable on a non-transitory storage medium. The non-transitory storage medium can be any media that can contain, store, or maintain programs and data for use by or in connection with an instruction execution system. Machine-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for processing object data for an apparatus, the apparatus being arranged to produce a three-dimensional object, the method comprising:
receiving object data comprising a vector representation of the three-dimensional object; and
processing the object data to generate a material volume coverage representation of the three-dimensional object,
the material volume coverage representation comprising at least one material volume coverage vector for at least one respective volume forming part of the three-dimensional object,
each material volume coverage vector representing a probabilistic distribution of materials available to the apparatus for production of the three-dimensional object, the probabilistic distribution relating to all combinations of said materials including separate use of materials, joint use of materials and an absence of any materials.

2. The method of claim 1, further comprising:
storing the material volume coverage representation as a file in a computer-readable storage medium for use in producing versions of the three-dimensional object.

3. The method of claim 1, further comprising:
applying halftoning to the material volume coverage representation of the three-dimensional object to generate control data for the apparatus for production of the three-dimensional object, the control data indicating discrete deposit instructions for the deposit of materials available to the apparatus.

4. The method of claim 3, further comprising:
producing the three-dimensional object using the apparatus based on the control data.

5. The method of claim 1, wherein processing the object data to generate a material volume coverage representation comprises:
determining a virtual resolution in three dimensions for a raster representation of the three-dimensional object; and
determining material volume coverage vectors for volumes defined at the determined resolution.

6. The method of claim 5, wherein the resolution is a virtual resolution independent of any production operation by the apparatus and the method comprises, at a production time:
determining a production configuration of the apparatus for production of the three-dimensional object, including determining a layer plane direction and a layer thickness;
applying halftoning to the material volume coverage representation of the three-dimensional object at a print resolution based on the production configuration to generate control data for the apparatus for production of the three-dimensional object, the control data indicating deposit instructions for the materials available to the apparatus; and
producing the three-dimensional object using the apparatus based on the control data.

7. The method of claim 6, wherein applying halftoning comprises one of:
applying a two-dimensional threshold matrix to each layer of the print resolution material volume coverage representation in the layer plane direction having the layer thickness; and
applying a three-dimensional threshold matrix to all three dimensions of the print resolution material volume coverage representation.

8. The method of claim 1, wherein processing the object data to generate a material volume coverage representation of the three-dimensional object comprises, for each given volume in a set of volumes forming part of a raster representation of the three-dimensional object:
determining whether a center of the given volume is within the three-dimensional object, as defined by the vector representation; and
responsive to the center of the given volume being within the three-dimensional object,
determining a set of properties for the given volume that are desired in a produced version of the three-dimensional object, and
calculating values for the material volume coverage vector for the given volume using a property-vector separation,
the property-vector separation mapping one or more property values to material volume coverage vector values.

9. The method of claim 8, wherein the set of properties comprise one or more of: material properties, mechanical properties, color, detail, roughness, conductivity and magnetism.

10. A file structure for use in production of a three dimensional object comprising:
a plurality of volume definitions having data defining the three dimensional object,
the plurality of volume definitions being within a virtual grid resolution in three dimensions,
each volume definition having:
a volume set by the virtual grid resolution, and
a material coverage vector for the volume,
the material coverage vector representing a probabilistic distribution of materials available to an apparatus for production of the three-dimensional object and combinations of said materials.

11. The file structure of claim 10, wherein the material coverage vector of each volume definition is linearly combinable in three dimensions.

12. The file structure of claim 10, wherein, for an apparatus having k available materials and L discrete deposit states for said materials, the material coverage vector comprises L^{k} vector components.

13. An apparatus arranged to produce a three-dimensional object comprising:
a data interface to receive a material volume coverage representation of the three-dimensional object,
the material volume coverage representation comprising at least one material volume coverage vector for at least one volume at a virtual resolution,
each material volume coverage vector representing a probabilistic distribution representative of a proportional volumetric coverage of materials available to the apparatus for production of the three-dimensional object and combinations of said materials;
a production controller communicatively coupled to the data interface to determine a production configuration of the apparatus for production of the three-dimensional object, the production configuration comprising a layer plane direction and a layer thickness,
wherein the production controller is configured to halftone at least one layer of the material volume coverage representation at a print resolution based on the production configuration to generate control data for production of at least one layer of the three-dimensional object, the control data indicating production instructions for the materials available to the apparatus.

14. The apparatus of claim 13, comprising:
at least one mechanism to produce the at least one layer of the three-dimensional object based on the control data.

15. The apparatus of claim 13, comprising:
a feedback interface to receive feedback from the production of the at least one layer of the three-dimensional object,
wherein the production controller is communicatively coupled to the feedback interface and is configured to modify the production configuration of the apparatus and halftone to at least one additional layer of the material volume coverage representation at a modified print resolution based on the modified production configuration to generate additional control data for production of at least one additional layer of the three-dimensional object.
